(19) United States
(12) Patent Application Publication
(10) Pub. No.: US 2023/0395298 A1
(43) Pub. Date: Dec. 7, 2023

(54) COIL COMPONENT

(71) Applicant: SAMSUNG ELECTRO-MECHANICS CO., LTD., Suwon-si (KR)

(72) Inventors: Dong Hwan LEE, Suwon-si (KR); Chan YOON, Suwon-si (KR); Dong Jin LEE, Suwon-si (KR); Jung Hyuk JUNG, Suwon-si (KR)

(73) Assignee: SAMSUNG ELECTRO-MECHANICS CO., LTD., Suwon-si (KR)

(21) Appl. No.: 18/095,162

(22) Filed: Jan. 10, 2023

(30) Foreign Application Priority Data
Jun. 7, 2022 (KR) 10-2022-0068863

(51) Int. Cl. H01F 17/00; H01F 27/29; H01F 27/00; H01F 17/04

(52) U.S. Cl. CPC H01F 17/0013; H01F 17/0033; H01F 27/292; H01F 27/006; H01F 17/04

(57) ABSTRACT

A coil component includes a body having first and second surfaces opposing each other in a first direction, first to third coil portions spaced apart from each other in the first direction in the body and having turns wound in the same direction, and an external electrode disposed on the body and connected to each of the first to third coil portions, wherein the number of turns of a portion of the first coil portion disposed in a region between a winding center of the first coil portion and the first surface is greater than the number of turns of a portion of the third coil portion disposed between a winding center of the third coil portion and the second surface, and wherein a distance between the first and second coil portions is wider than a distance between the second and third coil portions.

### CROSS-REFERENCE TO RELATED APPLICATION(S)

This application claims benefit of priority to Korean Patent Application No. 10-2022-0068863 filed on Jun. 7, 2022 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in electronic devices along with a resistor and a capacitor. Among coil components, there may be an array-type coil component including a plurality of coil portions in one component to reduce a mounting area.

Such an array-type coil component may have a non-coupled or coupled inductor form or a mixed form of the above forms depending on a coupling coefficient or mutual inductance between a plurality of coil portions.

Meanwhile, a non-coupled inductor in which a plurality of coils are spaced apart from each other may be required to be designed to similarly implement inductance and a mutual coupling coefficient of each coil.

### SUMMARY

An aspect of the present disclosure is to provide an array-type coil component which may, by implementing similar levels of inductance and coupling coefficients of coils in an inductor array, have uniform properties for each terminal.

According to an aspect of the present disclosure, a coil component includes a body having first and second surfaces opposing each other in a first direction, first to third coil portions spaced apart from each other in the first direction in the body and having turns wound in the same direction, and an external electrode disposed on the body and connected to each of the first to third coil portions, wherein a number of turns of a portion of the first coil portion disposed in a region between a winding center of the first coil portion and the first surface is greater than a number of turns of a portion of the third coil portion disposed between a winding center of the third coil portion and the second surface, and wherein a distance between the first and second coil portions is greater than a distance between the second and third coil portions.

According to another aspect of the present disclosure, a coil component includes a body having first and second surfaces opposing each other in a first direction, at least three coil portions spaced apart from each other in the first direction in the body and having turns wound in the same direction with respect to a core, respectively, and external electrodes disposed on the body and connected to both ends of the at least three coil portions, respectively, wherein, among the at least three coil portions, the coil portion nearest to the first surface is defined as a first outermost coil portion, and the coil portion nearest to the second surface is defined as a second outermost coil portion among the at least three coil portions, a number of turns of the first outermost coil portion in a region adjacent to the first surface is greater than a number of turns of the second outermost coil portion in a region adjacent to the second surface, and wherein a distance between the first outermost coil portion and an adjacent coil portion is greater than a distance between other adjacent coil portions among the other coil portions.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component according to a first embodiment of the present disclosure;

FIG. 2 is a plan diagram of the example embodiment shown in FIG. 1;

FIG. 3 illustrates a current direction and a core area based on the example embodiment in FIG. 2.

FIG. 4 is cross-sectional diagram taken along line I-I′ in FIG. 1, illustrating a magnetic flux flow of each coil portion;

FIG. 5 is a cross-sectional diagram taken along line II-II′ in FIG. 1;

FIG. 6 is a perspective diagram illustrating a coil component according to a second embodiment of the present disclosure;

FIG. 7 is a plan diagram of the example embodiment shown in FIG. 6, similar to FIG. 2; and

FIG. 8 is a perspective diagram illustrating a coil component according to a third embodiment of the present disclosure.

### DETAILED DESCRIPTION

The terms used in the example embodiments are used to simply describe an example embodiment, and are not intended to limit the present disclosure. A singular term includes a plural form unless otherwise indicated. The terms, “include,” “comprise,” “is configured to,” and the like, of the description are used to indicate the presence of features, numbers, steps, operations, elements, portions or combination thereof, and do not exclude the possibilities of combination or addition of one or more features, numbers, steps, operations, elements, portions or combination thereof. Also, the term “disposed on,” “disposed on,” and the like, may indicate that an element is disposed on or beneath an object, and may not necessarily mean that the element is disposed on the object with reference to a gravity direction.

The term “coupled to,” “combined to,” and the like, may not only indicate that elements are directly and physically in contact with each other, but also include the configuration in which the other element is interposed between the elements such that the elements are also in contact with the other component.

The size and thickness of each component in the drawings may be arbitrarily indicated for ease of description, and thus, the present disclosure is not necessarily limited to the illustrated examples.

In the drawings, an L direction is a first direction or a length direction, a W direction is a second direction or a width direction, a T direction is a third direction or a thickness direction.

Hereinafter, a coil component according to an example embodiment will be described in detail with reference to the accompanying drawings, and in the description with reference to the accompanying drawings, the same or corresponding components may be provided with the same reference numerals and overlapping description thereof will not be provided.

In electronic devices, various types of electronic components may be used, and various types of coil components may be used between the electronic components to remove noise, or for other purposes.

In other words, in electronic devices, a coil component may be used as a power inductor, a high frequency inductor (HF inductor), a general bead, a high frequency bead (GHz bead), a common mode filter, and the like.

### First Embodiment

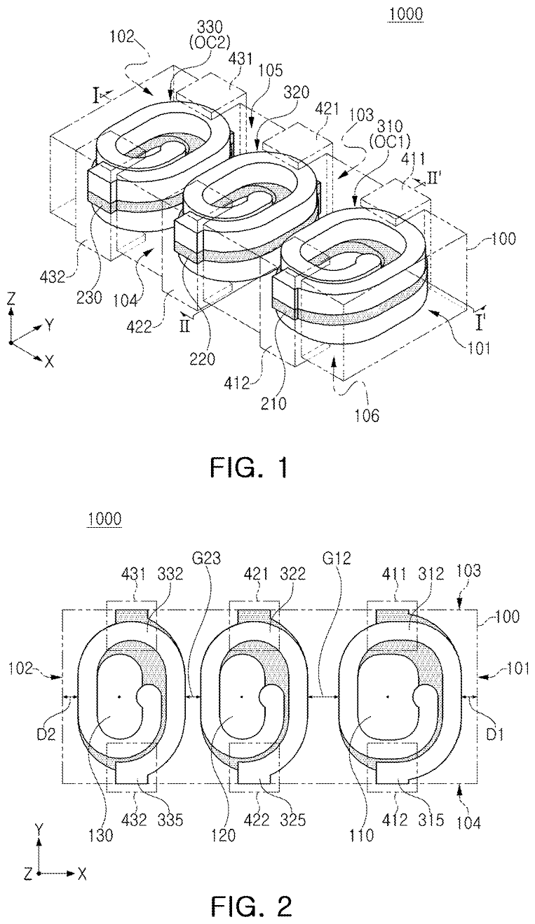

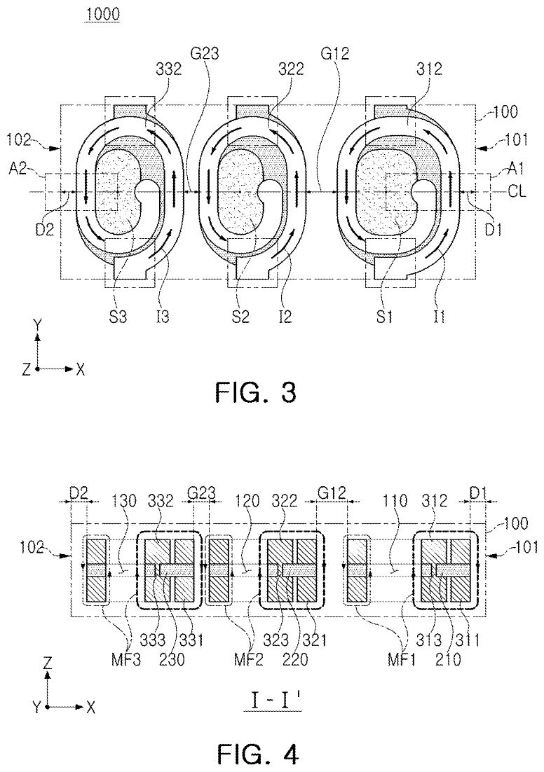

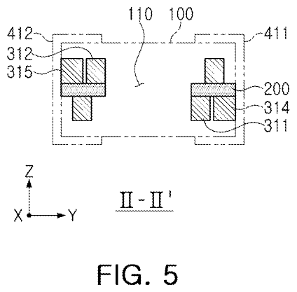

FIG. 1 is a perspective diagram illustrating a coil component according to a first embodiment. FIG. 2 is a plan diagram of the example embodiment shown in FIG. 1. FIG. 3 illustrates a current direction and a core area based on the example embodiment in FIG. 2. FIG. 4 is cross-sectional diagram taken along line I-I′ in FIG. 1, illustrating a magnetic flux flow of each coil portion. FIG. 5 is a cross-sectional diagram taken along line II-II′ in FIG. 1.

Referring to FIGS. 1 to 5, the coil component 1000 according to the example embodiment is the body 100 may include first to third coil portions 310, 320, and 330, and first to sixth external electrodes 411, 412, 421, 422, 431, and 432, and may further include substrates 210, 220, and 230.

The body 100 may form an exterior of the coil component 1000 in the example embodiment, and the first to third coil portions 310, 320, and 330, and the substrates 210, 220, and 230 may be embedded therein. Meanwhile, in the example embodiment, three coil portions 310, 320, and 330 may be disposed in the body 100, but an example embodiment thereof is not limited thereto, and three or more coil portions may be disposed.

The body 100 may have a substantially hexahedral shape.

Referring to FIG. 1, the body 100 may include a first surface 101 and a second surface 102 opposing each other in the first direction (the X-direction), a third surface 103 and a fourth surface 104 opposing each other in the second direction (the Y-direction), and a fifth surface 105 and a sixth surface 106 opposing each other in the third direction (the Z-direction), with respect to the directions in FIG. 1. Each of the first to fourth surfaces 101, 102, 103 and 104 of the body 100 may be a wall surface of the body 100 connecting the fifth surface 105 to the sixth surface 106 of the body 100. Hereinafter, both end surfaces (one end surface and the other end surface) of the body 100 may refer to the first surface 101 and the second surface 102 of the body 100, both side surfaces (one side surface and the other side surface) of the body 100 may refer to the third surface 103 and the fourth surface 104 of the body 100, one surface may refer to the sixth surface 106, and the other surface of the body 100 may refer to the fifth surface 105. Also, hereinafter, the upper surface and the lower surface of the body 100 may refer to the fifth surface 105 and the sixth surface 106 of the body 100, respectively, determined with respect to the direction of FIG. 1.

The body 100 may include an insulating resin and a magnetic material. Specifically, the body 100 may be formed by laminating one or more magnetic composite sheets in which a magnetic material is dispersed in an insulating resin. However, the body 100 may have a structure different from a structure in which a magnetic material is dispersed in a resin. For example, the body 100 may be formed of a magnetic material such as ferrite.

The magnetic material may be ferrite or metallic magnetic powder.

The ferrite may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an example embodiment thereof is not limited thereto.

Each particle of ferrite and magnetic metal powder may have an average diameter of about 0.1 μm to 30 μm, but an example embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

The insulating resin may include epoxy, polyimide, a liquid crystal polymer, or the like, alone or in combination but an example embodiment thereof is not limited thereto.

The body 100 may include a first core 110 penetrating through the first coil portion 310, a second core 120 penetrating through the second coil portion 320, and a third core 130 penetrating through the third coil portion 330.

Also, when the first to third substrates 210, 220, and 230 are disposed in the body 100, the first to third cores 110, 120, and 130 may penetrate through the first to third substrates 210, 220, and 230.

Referring to FIGS. 1 to 3, the first to third cores 110, 120, and 130 may be disposed in winding center regions of the first to third coil portions 310, 320, and 330 to be described later, respectively, and the cross-sectional area S1 of the first core 110 may be configured to be different from the cross-sectional areas S2 and S3 of the second and third cores, respectively.

For example, the cross-sectional area of the first core 110 penetrating through the center of the first coil portion 310 having the largest number of turns in the region adjacent to the first surface 101 or the second surface 102 of the body 100 may be configured to be larger than the cross-sectional area of each of the second or third coil portions 320 and 330. As described above, by adjusting only the core area S1 of the first coil portion 310 while maintaining the cross-sectional areas of the second and third coil portions 320 and 330 as are, inductance properties of each of the coil portions 310, 320, and 330 may be uniformly implemented in the coil component 1000 according to the example embodiment, a detailed description of which will be described later. In some embodiments, the cross-sectional area of the second core may be the same as the cross-sectional area of the third core.

The first to third cores 110, 120, and 130 may be formed as a at least a portion of the magnetic composite sheet fills a through-hole of each of the first to third coil portions 310, 320, and 330 in the process of laminating and curing the magnetic composite sheet, but an example embodiment thereof is not limited thereto.

The substrates 210, 220, and 230 may be embedded in the body 100. The substrates 210, 220, and 230 may be configured to support the coil portions 310, 320, and 330 to be described later.

The substrates 210, 220, and 230 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material such as glass fiber or inorganic filler. For example, the substrates 210, 220, and 230 may be formed of an insulating material such as prepreg, Ajinomoto build-up film (ABF), FR-4, bismaleimide triazine (BT) film, and photo imaginable dielectric (PID) film, but an example embodiment thereof is not limited thereto.

As inorganic fillers, at least one selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (Mg₀), boron nitride (BN), aluminum borate (AlBO₃), barium titanate (BaTiO₃) and calcium zirconate (CaZrO₃) may be used.

When the substrates 210, 220, and 230 are formed of an insulating material including a reinforcing material, the substrates 210, 220, and 230 may provide excellent rigidity. When the substrates 210, 220, and 230 are formed of an insulating material not including glass fiber, the substrates 210, 220, and 230 may be advantageous in reducing the thickness of the components. When the substrates 210, 220, and 230 are formed of an insulating material including a photosensitive insulating resin, the number of processes for forming the coil portions 310, 320, and 330 may be reduced, which may be advantageous in reducing production costs and forming fine vias.

The first to third coil portions 310, 320, and 330 may be disposed in the body 100, may be spaced apart from each other, and may exhibit properties of the coil component 1000 according to the example embodiment. For example, in the coil component 1000 according to the example embodiment, an absolute value of a coupling coefficient k between the first to third coil portions 310, 320, and 330 may be greater than 0 and less than 0.05, but an example embodiment thereof is not limited thereto.

Referring to FIGS. 1 to 3, the first to third coil portions 310, 320, and 330 may be spaced apart from each other in the first direction (X-direction) in the body 100, and may have turns wound in the same direction.

Referring to FIGS. 1 and 4 to 5, the first coil portion 310 may include a first coil pattern 311 disposed on the lower surface of the first substrate 210 with respect to the direction in FIG. 1, a second coil pattern 312 disposed on the upper surface of the first substrate 210, and a first via 313 penetrating through the first substrate 210 and connecting the first and second coil patterns 311 and 312 to each other. Also, the first coil portion 310 may further include first and second lead-out portions 314 and 315 extending from the external ends of the first and second coil patterns 311 and 312, respectively, and connected to the first and second external electrodes 411 and 412 on the third and fourth surfaces 103 and 104 of the body 100, respectively. Accordingly, the first coil portion 310 may function as a single coil between the first and second external electrodes 411 and 412.

Also, the second coil portion 320 may include a third coil pattern 321 disposed on the lower surface of the second substrate 220, a fourth coil pattern 322 disposed on the upper surface of the second substrate 220, and a second via 323 penetrating through the second substrate 220 and connecting the third and fourth coil patterns 321 and 322 to each other, with reference to the direction in FIG. 1. The second coil portion 320 may further include third and fourth lead-out portions 324 and 325 extending from the external ends of the third and fourth coil patterns 321 and 322, and connected to the third and fourth external electrodes 421 and 422 on the third and fourth surfaces 103 and 104 of the body 100, respectively. Accordingly, the second coil portion 320 may function as a single coil between the third and fourth external electrodes 421 and 422.

Also, the third coil portion 330 may include the fifth coil pattern 331 disposed on the lower surface of the third substrate 230, the sixth coil pattern 332 disposed on the upper surface of third substrate 230, and a third via 333 penetrating through the third substrate 230 and connecting the fifth and sixth coil patterns 331 and 332 to each other, with respect to the direction in FIG. 1. The third coil portion 330 may further include fifth and sixth lead-out portions 334 and 335 extending from the external ends of the fifth and sixth coil patterns 331 and 332, respectively, and connected to the fifth and sixth external electrodes 431 and 432 on the third and fourth surfaces 103 and 104 of the body 100. Accordingly, the third coil portion 330 may function as a single coil between the fifth and sixth external electrodes 431 and 432.

As such, in the coil component 1000 according to the example embodiment, each of the first to third coil portions 310, 320, and 330 disposed in the body 100 may function as a single coil, such that the coil component 1000 is mounted on a printed circuit board (PCB) and energized, the coil component 1000 may be affected by mutual inductance between the coil portions adjacent to each other.

Referring to FIGS. 3 and 4, when the winding directions of the first to third coil portions 310, 320, and 330 are the same, current directions between adjacent coil portions may be opposite to each other during energization, such that negative coupling may occur.

Accordingly, even when the winding directions of the coil portion 310, 320, and 330, the overall lengths of the coil patterns 311, 312, 321, 322, 331, and 332, the cross-sectional areas S, S2, and S3 of the core 110, 120, and 130, and the distances G12 and G23 between the coil portions adjacent to each other are configured to be the same, the number of turns in the regions in which the first and third coil portions 310 and 330 disposed on the outermost side are in contact with the first surface 101 and the second surface 102 of the body 100, respectively, may be different, such that there may be a difference in inductance properties between the coil portions 310, 320, and 330 during energization.

As an example, referring to FIG. 3, assuming a center line CL penetrating through the winding center of each coil portion 310, 320, and 330 in the X-direction with respect to the X-Y plane, the number of turns of the first coil portion 310 disposed in the area A1 between the winding center of the 310 (or the winding center of the second coil pattern 312) and the first surface 101 of the body 100 may be greater than the number of turns of the third coil portion 330 disposed in the area A2 between the winding center is (or the winding center of the sixth coil pattern 332) of the third coil portion 330 and the second surface 102 of the body 100. For example, in the example embodiment, 1.5 turns of the first coil portion 310 may pass in area A1, and 1 turn of the third coil portion 330 may pass in area A2.

In the coil component 1000 according to the example embodiment, with respect to the first coil portion 310 having the largest number of turns disposed in the area A1 between the winding center and the first surface 101 of the body 100, by adjusting the distance G12 from the adjacent second coil portion 320, the cross-sectional area S1 of the first core 110 in the center of the first coil portion 310, or the length of the entire turn of the first coil portion 310, inductance of each coil portion 310, 320, and 330 in the coil component 1000 according to the example embodiment may be uniformly implemented.

That is, when at least three or more coil portions are disposed in the body 100 and each coil portion has turns wound in the same direction, the other coil portions may be formed identically to each other, and the distance and the cross-sectional area of the core may be adjusted with respect to one of the outermost coil portions, such that inductance properties of each coil portion may be uniformly implemented, and a production efficiency may be increased and a defect rate may be reduced.

Meanwhile, in the example embodiments, the first and second outermost coil portions OC1 and OC2 may refer to two coil portions disposed on the outermost side in the X-direction. For example, in the example embodiment, the first outermost coil portion OC1 may be the same as the first coil portion 310, and the second outermost coil portion OC2 may be the same as the third coil portion 330.

Referring to FIGS. 1 to 4, the number of turns of the portion of the first coil portion 310 disposed in the region A1 between the winding center of the first coil portion 310 and the first surface 101 of the body 100 may be greater than the number of turns of the portion of the third coil portion 330 disposed in the region A2 between the winding center of the third coil portion 330 and the second surface 102 of the body 100. In some embodiments, a number of turns of the third coil portion 330 may be the same as a number of turns of the second coil portion 320.

Here, the distance G12 between the first and second coil portions 310 and 320 may be wider (greater) than the distance G23 between the second and third coil portions 320 and 330. Also, the distance D1 between the first coil portion 310 and the first surface 101 of the body 100 may be the same as the distance D2 between the third coil portion 330 and the second surface 102 of the body 100, but an example embodiment thereof is not limited thereto, and the distances may be formed differently if desired.

Referring to FIG. 3, the winding directions of the first to third coil portions 310, 320, and 330 may be the same. Accordingly, the direction I1 of the current flowing through the coil pattern 312 of the first coil portion 310, the direction I2 of the current flowing through the coil pattern 322 of the second coil portion 320, and the direction I3 of the current flowing through the coil pattern 332 of the third coil portion 330 may be the same.

Accordingly, in the region between the two coil portions adjacent to each other, the directions of the magnetic fluxes induced due to the opposite directions of the currents may also be opposite to each other, such that negative coupling may occur. That is, negative coupling may occur in a region in which the first and second coil portions 310 and 320 are adjacent to each other. Also, negative coupling may occur in a region in which the second and third coil portions 320 and 330 are adjacent to each other.

Referring to FIG. 4, MF1, MF2, and MF3 may represent magnetic flux flows when the first to third coil portions 310, 320, and 330 are energized, respectively. The amount of magnetic flux may increase in the regions in which the coil portion 310, 320, and 330 have a large number of turns. When the region in which a large number of turns are present, such as first coil portion 310, is adjacent to the first surface 101 of the body 100, by configuring the lengths of the turns of the coil portion 310, 320, and 330 to be the same and the distances G12 and G23 between the coil portion 310, 320, and 330 to be constant, inductance of the coil portion 310 may decrease, and the coupling coefficient k between the first and second coil portions 310 and 320 may increase.

To uniformly implement the inductances and coupling coefficients of the coil portions 310, 320, and 330 by compensating for the decrease of inductance and the increase of coupling coefficient, in the coil component 1000 according to the example embodiment, the coupling coefficient between the first and second coil portions 310 and 320 may be decreased by adjusting the distance G12 between the first and second coil portions 310 and 320, and inductance of the first coil portion 310 may be increased by adjusting the cross-sectional area S1 of the first core 110 and the length of an entirety of the turn of the first coil portion 310.

Specifically, referring to FIGS. 2 to 3, the distance G12 between the first and second coil portions 310 and 320 may be configured to be greater than the distance G23 between the second and third coil portions 320 and 330.

Here, the distances G12 and G23 between the coil portions 310, 320, and 330 may refer to an arithmetic mean value of at least three or more of the dimensions of a plurality of line segments connecting two outermost boundary lines of the adjacent coil portions opposing each other in the first direction (the X-direction), and the plurality of line segments may be parallel to each other and the first direction (the X-direction), with respect to an optical microscope image or a scanning electron microscope (SEM) image with respect to the X-Y cross-section on which the coil patterns 312, 322, and 332 are illustrated, taken from the central portion of the coil component 1000 taken in the third direction (the Z-direction). Here, the plurality of line segments parallel to the first direction (the X-direction) may be spaced spart from each other by an equal distance in the second direction (the Y-direction), but an example embodiment thereof is not limited thereto. Other methods and/or tools appreciated by one of ordinary skill in the art, even if not described in the present disclosure, may also be used to measure the distances G12 and G23.

Also, among the cross-sectional areas S1, S2, and S3 of the first to third cores 110, 120, and 130 disposed in the central regions of the first to third coil portions 310, 320, and 330, respectively, the cross-sectional area S1 of the first core 110 may be configured to be different from the cross-sectional areas S2 and S3 of the second and third cores 120 and 130, respectively. For example, the cross-sectional area S1 of the first core 110 may be larger than the cross-sectional areas S2 and S3 of the second and third cores 120 and 130, but an example embodiment thereof is not limited thereto.

Here, the cross-sectional areas S1, S2, and S3 of each of the cores 110, 120, and 130 may be calculated using the Image J program tool based on an optical microscope or a scanning electron microscope (SEM) image with respect to the X-Y cross-sections taken from the central portion of the coil component 1000 in the third direction (Z-direction), for example, but an example embodiment thereof is not limited thereto. Other methods and/or tools appreciated by one of ordinary skill in the art, even if not described in the present disclosure, may also be used.

Also, the length of the entire turn of the first coil portion 310 may be configured to be different from the length of each of the total turns of the second and third coil portions 320 and 330. For example, the length of the entire turn of the first coil portion 310 may be longer than the length of each of the turns of the second and third coil portions 320 and 330, but an example embodiment thereof is not limited thereto. In some embodiments, the length of the entirety of the turn of the second coil portion 320 may be the same as the length of the entirety of the turn of the third coil portion 330.

Here, the length of the entire turn of each coil portion 310, 320, and 330 may be calculated using the Image J program tool based on an optical microscope or a scanning electron microscope (SEM) image with respect to the X-Y cross-sections on which the coil patterns 312, 322, and 332 are illustrated, taken from the central portion of the coil component 1000 in the third direction (Z-direction), for example, but an example embodiment thereof is not limited thereto. Other methods and/or tools appreciated by one of ordinary skill in the art, even if not described in the present disclosure, may also be used.

Meanwhile, by adjusting the distance D1 between the first outermost coil portion OC1, that is, the first coil portion 310 and the first surface 101 of the body 100, the amount of the magnetic material in which the magnetic flux may pass through may increase. Specifically, if desired, the distance D1 between the first coil portion 310 and the first surface of the body 100 may be adjusted to be different from the distance between the second outermost coil portion OC2, that is, the third coil portion 330 and the second surfaces 102 of the body 100. For example, the distance D1 between the first coil portion 310 and the first surface of the body 100 may be wider (greater) than the distance between the third coil portion 330 and the second surface 102 of the body 100, but an example embodiment thereof is not limited thereto.

Here, the distance D1 and D2 between the outermost coil portion OC1 and OC2 and the first surface 101 and the second surface 102 of the body 100, respectively, may refer to, for example, an arithmetic mean value of at least three or more of the dimensions of a plurality of line segments connecting two outermost boundary lines of the first surface 101 or the second surface 102 of the body, opposing the outermost boundary lines of the coil patterns 312 and 332 illustrated in the cross-sectional image in the first direction (the X-direction), and the plurality of line segments may be parallel to each other and the first direction (the X-direction), based on an optical microscope image or a scanning electron microscope (SEM) image with respect to the X-Y cross-section on which the coil patterns 312, 322, and 332 are illustrated, taken from the central portion of the coil component 1000 taken in the third direction (the Z-direction). Here, the plurality of line segments parallel to the first direction (the X-direction) may be spaced spart from each other by an equal distance in the second direction (the Y-direction), but an example embodiment thereof is not limited thereto.

Each of the first to third coil portions 310, 320, and 330 may include a seed layer in contact with the substrates 210, 220, and 230, and a plating layer disposed on the seed layer. That is, the first to third coil portions 310, 320, and 330 applied to the example embodiment may be a thin film type coil formed by a plating method.

The seed layer may be formed by a thin film process such as sputtering or an electroless plating process. When the seed layer is formed by a thin film process such as sputtering, the seed layer may have a form in which at least a portion of the material forming the seed layer may permeate into the surface of the substrates 210, 220, and 230, which may occur because the concentration of the metal material forming the seed layer in the substrates 210, 220, and 230 may not be uniform in the third direction (Z-direction) of the body 100.

The thickness of the seed layer may be 1.5 μm or more and 3 μm or less. When the thickness of the seed layer is less than 1.5 μm, it may be difficult to implement the seed layer, such that a plating defect may occur in a subsequent process. When the thickness of the seed layer is greater than 3 μm, it may be difficult to form a relatively large volume of the plating layer within the limited volume of the body 100, and the process time may increase.

The vias 313, 323, and 333 may include at least one conductive layer. For example, when the vias 313, 323, and 333 are formed by electroplating, the vias 313, 323, and 333 may include a seed layer formed on an inner wall of a via hole penetrating through the substrate 210, 220, and 230, and an electroplating layer filling the via hole in which the seed layer is formed. The seed layers of the vias 313, 323, and 333 may be formed together with the seed layers of the first to third coil portions 310, 320, and 330 in the same process and may be integrated with each other, or the seed layers of the vias 313, 323, and 333 may be formed in the process different from the process of forming the seed layer of the first to third coil portions 310, 320, and 330 such that a boundary may be formed therebetween. The electrolytic plating layers of the vias 313, 323, and 333 may be formed together with the plating layers of the first to third coil portions 310, 320 and 330 in the same process and may be integrated with each other, or the electrolytic plating layers of the vias 313, 323, and 333 may be formed in the process different from the process of forming the plating layers of the first to third coil portions 310, 320, and 330 such that a boundary may be formed therebetween.

When the line widths of the coil patterns 311, 312, 321, 322, 331, and 332 are excessively large, the volume of the magnetic material in the volume of the same body 100 may be reduced, such that component properties may be deteriorated. As an example, but not limited thereto, the ratio of the thickness to the line width of each turn of the coil patterns 311, 312, 321, 322, 331, and 332, that is, an aspect ratio AR may be 3:1 to 9:1, based on the Y-Z cross section.

Each of the coil patterns 311, 312, 321, 322, 331, and 332 and vias 313, 323, and 333 may be formed of a conductive material such as copper (Cu), aluminum (Al), silver (Ag), tin (Sn), gold (Au), nickel (Ni), lead (Pb), titanium (Ti), chromium (Cr), or alloys thereof, but an example embodiment thereof is not limited thereto. As an example, but not limited thereto, the seed layer may include at least one of molybdenum (Mo), chromium (Cr), copper (Cu), and titanium (Ti), and the plating layer may include copper (Cu).

The first to sixth external electrodes 411, 412, 421, 422, 431, and 432 may be disposed on the third surface 103 or the fourth surface 104 of the body 100 and may be connected to both ends of the first to third coil portions 310, 320, and 330, respectively.

The first to sixth external electrodes 411, 412, 421, 422, 431, and 432 may function as terminals transmitting a signal to the coil portions 310, 320, and 330 when the coil component 1000 according to the example embodiment is mounted on a printed circuit board (PCB).

Referring to FIGS. 1, 3 and 5, the first external electrode 411 may be disposed on the third surface 103 of the body 100 and may be in contact with and connected to the first lead-out portion 314 of the first coil portion 310 exposed to the third surface 103 of the body 100. The second external electrode 412 may be disposed on the fourth surface 104 of the body 100 and may be in contact with and connected to the second lead-out portion 315 of the first coil portion 310 exposed to the fourth surface 104 of the body 100.

Also, the third external electrode 421 may be in contact with and connected to the lead-out portion 324 of the coil portion 320 disposed on the third surface 103 of the body 100 and exposed to the third surface 103 of the body 100. The fourth external electrode 422 may be in contact with and connected to the fourth lead-out portion 325 disposed on the fourth surface 104 of the body 100 exposed to the fourth surface 104 of the body 100.

Also, the fifth external electrode 431 may be in contact with and connected to the fifth lead-out portion 334 disposed on the third surface 103 of the body 100 and exposed to the third surface 103 of the body 100. The sixth external electrode 432 may be in contact with and connected to the sixth lead-out portion 335 of the third coil portion 330 disposed on the fourth surface 104 of the body 100 and exposed to the fourth surface 104 of the body 100.

The first, third and fifth external electrodes 411, 421, and 431 may be disposed on the third surface 103 of the body 100 and may be spaced apart from each other, and the second, fourth, and sixth external electrodes 412, 422, and 432 may be spaced apart from each other on the fourth surface 104 of the body 100.

Referring to FIGS. 1 to 3, on the third surface 103 of the body 100, the distance between the first external electrode 411 and the third external electrode 421 may be greater than the distance between the third external electrode 421 and the fifth external electrode 431. Also, on the fourth surface 104 of the body 100, the distance between the second external electrode 412 and the fourth external electrode 422 may be greater than the distance between the fourth external electrode 422 and the sixth external electrode 432.

The first to sixth external electrodes 411, 412, 421, 422, 431, and 432 may be formed of a conductive material such as copper (Cu), aluminum (Al), silver (Ag), tin (Sn), gold (Au), nickel (Ni), lead (Pb), titanium (Ti), or alloys thereof, but an example embodiment thereof is not limited thereto.

The first to sixth external electrodes 411, 412, 421, 422, 431, and 432 may be formed in a single-layer structure or a multiple-layer structure. For example, the first external electrode 411 may include a first layer including copper, a second layer disposed on the first layer and including nickel (Ni), and a third layer disposed on the second layer and including tin (Sn). Here, each of the first to third layers may be formed by plating, but an example embodiment thereof is not limited thereto. As another example, the first external electrode 411 may include a resin electrode layer including conductive powder and a resin, and a plating layer formed by plating on the resin electrode layer. In this case, the resin electrode layer may include a conductive powder of at least one of copper (Cu) and silver (Ag) and a cured product of a thermosetting resin. Also, the plating layer may include a first plating layer including nickel (Ni) and a second plating layer including tin (Sn). When the resin included in the resin electrode layer includes the same resin as the insulating resin of the body 100, bonding force between the resin electrode layer and the body 100 may improve.

Meanwhile, although not illustrated, when the body 100 includes a conductive magnetic material, the coil component 1000 according to the example embodiment may further include an insulating layer disposed on the surfaces of the first to third coil portions 310, 320, and 330.

### Second Embodiment

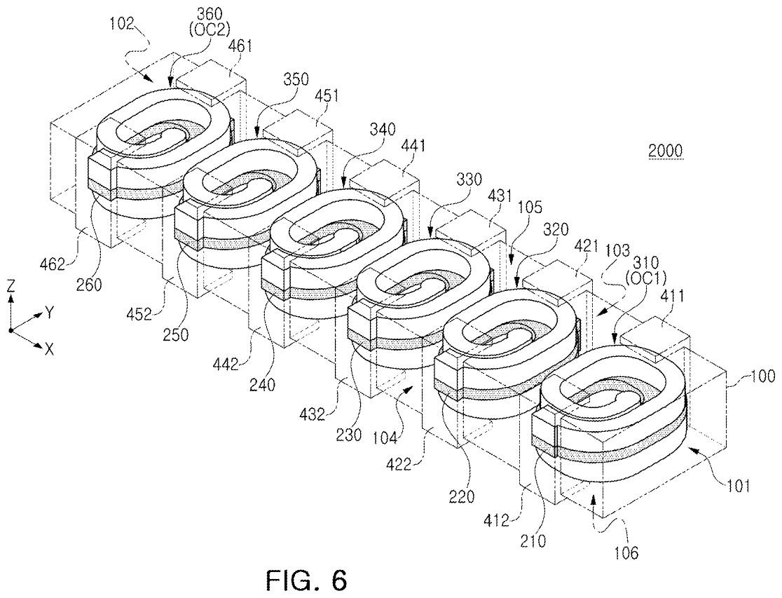

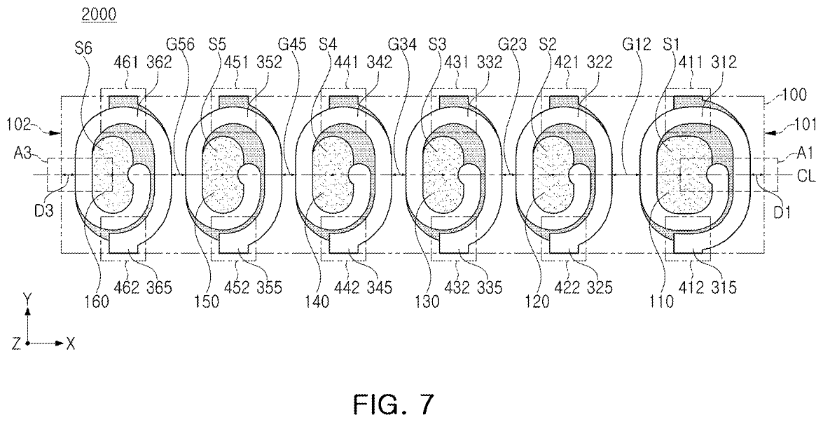

FIG. 6 is a perspective diagram illustrating a coil component according to a second embodiment. FIG. 7 is a plan diagram of the example embodiment shown in FIG. 6, similar to FIG. 2.

Referring to FIGS. 6 and 7, in the coil component 2000 according to the example embodiment, the number of coil portions may be different as compared to the coil component 1000 according to the first embodiment. That is, the generalized structure of an inductor array including at least three or more coil portions is illustrated, and in the example embodiment, six coil portions 310, 320, and 330, 340, 350, 360 may be included, but an example embodiment thereof is not limited thereto.

Therefore, in describing the example embodiment, merely the structure related to the fourth to sixth coil portions 340, 350, and 360, fourth to sixth cores 140, 150, and 160, the fourth to sixth substrates 240, 250, and 260 and the seventh to twelfth external electrodes 441, 442, 451, 452, 461, and 462 further added as compared to the first embodiment will be described. For the rest of the components of the example embodiment, the description in the first embodiment may be applied as is.

Referring to FIGS. 6 and 7, the coil component 2000 according to the example embodiment may include the first to sixth coil portions 310, 320, 330, 340, 350, and 360 and the first to sixth cores 110, 120, 130, 140, 150, and 160 penetrating the coil portions. Also, the coil component 2000 may further include the first to sixth substrates 210, 220, 230, 240, 250, and 260 disposed in the body 100 and supporting the first to sixth coil portions 310, 320, 330, 340, 350 and 360.

The first to sixth coil portions 310, 320, 330, 340, 350, and 360 may be spaced apart from each other in the first direction (X-direction) in the body 100, and the first to sixth cores 110, 120, 130, 140, 150, and 160 may have turns wound in the same direction.

The coil component 2000 according to the example embodiment may further include first to twelfth external electrodes 411, 412, 421, 422, 431, 432, 441, 442, 451, 452, 461, and 462 disposed on the third surface 103 and the fourth surface 104 of the body 100 and connected to both ends of the first to sixth coil portions 310, 320, 330, 340, 350 and 360, respectively.

Referring to FIG. 7, in the coil component 2000 according to the example embodiment, the first coil portion 310 having the largest number of turns, disposed in the regions A1 and A3 between the first or second surfaces 101 and 102 of the body 100 and the winding center of the coil portion may correspond to the first outermost coil portion and the sixth coil portion 360 adjacent to the second surface 102 of the body 100 may correspond to the second outermost coil portion OC2.

The first outermost coil portion OC1, that is, the distance G12 between the first coil portion 310 and the second coil portion 320 adjacent to the first coil portion 310 may be greater than the distances G23, G34, G45, and G56 between the coil portions adjacent to each other among the other coil portions.

The distance D1 between the first outermost coil portion OC1 and the first surface 101 of the body 100 may be substantially the same as the distance D3 between the second outermost coil portion OC2 and the second surface 102 of the body 100, but an example embodiment thereof is not limited thereto. D1 and D3 may be measured in the same way as D1 and D2 in the first embodiment. The configuration in which D1 and D3 are substantially the same may include process errors or positional deviations occurring during the manufacturing process, and errors during measurement.

The cross-sectional area S1 of the first outermost coil portion OC1, that is, the first core 110 disposed in the winding center region of the first coil portion 310, may be configured to be greater than the cross-sectional area of each of the second to sixth cores 120, 130, 140, 150, and 160 disposed in the winding center region of each of the other coil portions 320, 330, 340, 350, and 360.

Also, each of the second to sixth cores 120, 130, 140, 150, and 160 may have a constant cross-sectional area. That is, the cross-sectional areas S2, S3, S4, S5, and S6 of each of the second to sixth cores 120, 130, 140, 150 and 160 may be configured to be substantially the same, but an example embodiment thereof is not limited thereto. Here, the configuration in which the cross-sectional areas are substantially the same may include process errors or positional deviations occurring during the manufacturing process, and errors during measurement.

The length of the entire turn of the first outermost coil portion OC1, that is, the first coil portion 310, may be longer than the length of each of the other coil portions 320, 330, 340, 350, and 360.

Also, each of the other coil portions 320, 330, 340, 350, and 360 other than the first outermost coil portion OC1 may be formed to have a constant length of the entire turn. That is, the length of each of the turns of the second to sixth coil portions 320, 330, 340, 350, and 360 may be substantially the same, but an example embodiment thereof is not limited thereto. Here, the configuration in which the lengths may be substantially the same may include process errors or positional deviations occurring during the manufacturing process, and errors during measurement.

Even in the case of an inductor array including a plurality of coil portions as the coil component 2000 according to the example embodiment, by adjusting the distance G12 from the adjacent coil portion, the area S1 of the first core, or the length of the entire turn with respect to the first outermost coil portion OC1, inductance properties of each coil portion may be uniformly implemented during energization.

### Third Embodiment

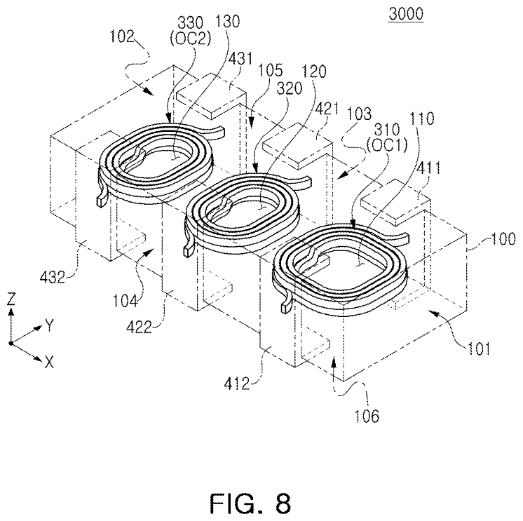

FIG. 8 is a perspective diagram illustrating a coil component according to a third embodiment.

Referring to FIG. 8, the coil component 3000 according to the example embodiment may be different from the coil component 1000 according to the first embodiment in that the coil component 3000 does not include the substrates 210, 220, and 230, and the structure of the coil portions 310, 320, and 330.

Therefore, in describing the example embodiment, only the coil portions 310, 320, and 330 different from the first embodiment will be described, and for the rest of the components of the example embodiment, the description in the first embodiment may be applied as it is. Meanwhile, in the example embodiment, six coil portions 310, 320, 330, 340, 350, and 360 may be arranged in the body 100, but an example embodiment thereof is not limited thereto, and three or more coil portions may be disposed.

Referring to FIG. 8, the first to third coil portions 310, 320, and 330 may be wound coils in which a metal wire coated with a coating layer is wound. Here, the covering layer may be formed of an insulating material.

The first to third coil portions 310, 320, and 330 may have a spiral shape forming at least one turn around the first to third cores 110, 120, and 130, respectively, but an example embodiment thereof is not limited thereto.

Both ends of the first to third coil portions 310, 320, and 330 may be extended and exposed to the third surface 103 and the fourth surface 104 of the body 100, respectively, and the external electrodes 411, 412, 422, 422, 431, and 432.

The metal wires included in the first to third coil portions 310, 320, and 330 may be formed of a conductive material such as copper (Cu), aluminum (Al), silver (Ag), tin (Sn), gold (Au), nickel (Ni), lead (Pb), titanium (Ti), chromium (Cr), molybdenum (Mo), or alloys thereof, but an example embodiment thereof is not limited thereto.

The coating layer for coating the metal wire may include an insulating material such as enamel, parylene, epoxy, and polyimide. A fusion layer may be further formed on the coating layer. In this case, the metal wire, which is a wire rod, may be wound in a coil shape, and may be integrated with the fusion layer of the metal wire forming the turns adjacent to each other by heat and pressure, but an example embodiment thereof is not limited thereto.

In FIG. 8, the coil portions 310, 320, and 330 in the example embodiment may be alpha-shaped windings, but an example embodiment thereof is not limited thereto, and edge-wise winding shape may also be included in the example embodiment thereof.

According to the aforementioned example embodiments, in the array-type coil component, terminals may have uniform inductance properties.

While the example embodiments have been illustrated and described above, it will be apparent to those skilled in the art that modifications and variations could be made without departing from the scope of the present disclosure as defined by the appended claims.

What is claimed is:

1. A coil component, comprising:
a body having first and second surfaces opposing each other in a first direction;
first to third coil portions spaced apart from each other in the first direction in the body and having turns wound in the same direction; and
an external electrode disposed on the body and connected to each of the first to third coil portions,
wherein a number of turns of a portion of the first coil portion disposed in a region between a winding center of the first coil portion and the first surface is greater than a number of turns of a portion of the third coil portion disposed between a winding center of the third coil portion and the second surface, and
wherein a distance between the first and second coil portions is greater than a distance between the second and third coil portions.

2. The coil component of claim 1, further comprising
first to third cores disposed in winding center regions of the first to third coil portions, respectively,
wherein a cross-sectional area of the first core is different from a cross-sectional area of each of the second and third cores.

3. The coil component of claim 2, wherein a cross-sectional area of the first core is greater than a cross-sectional area of each of the second and third cores.

4. The coil component of claim 1, wherein a length of an entirety of the turn of the first coil portion is different from a length of an entirety of the turn of each of the second and third coil portions.

5. The coil component of claim 4, wherein the length of the entirety of the turn of the first coil portion is longer than the length of the entirety of the turn of each of the second and third coil portions.

6. The coil component of claim 1, wherein a distance between the first coil portion and the first surface is different from a distance between the third coil portion and the second surface.

7. The coil component of claim 6, wherein the distance between the first coil portion and the first surface is greater than the distance between the third coil portion and the second surface.

8. The coil component of claim 1, wherein negative coupling occurs in a region in which the first and second coil portions are adjacent to each other.

9. The coil component of claim 1, wherein negative coupling occurs in a region in which the second and third coil portions are adjacent to each other.

10. The coil component of claim 1,
wherein the body further includes a third surface and a fourth surface connecting the first surface to the second surface and opposing each other in a second direction, and
wherein both ends of the first to third coil portions extend to the third surface and the fourth surface, respectively.

11. The coil component of claim 10,
wherein the external electrode include:
first and second external electrodes connected to the both ends of the first coil portion, respectively,
third and fourth external electrodes connected to the both ends of the second coil portion, respectively, and
fifth and sixth external electrodes connected to the both ends of the third coil portion, respectively, and
wherein a distance between the first external electrode and the third external electrode is greater than a distance between the third external electrode and the fifth external electrode on the third surface of the body.

12. The coil component of claim 10, further comprising:
a substrate disposed in the body and including the first to third coil portions disposed therein.

13. The coil component of claim 12, wherein the first to third coil portions include coil patterns disposed on both surfaces of the substrate, respectively, vias penetrating through the substrate and connecting internal ends of the coil patterns on the both surfaces of the substrate, respectively, and lead-out portions extending from external ends of the coil patterns to the third and fourth surfaces of the body and in contact with the external electrode.

14. The coil component of claim 1, wherein the first to third coil portions include a wound metal wire coated with a coating layer.

15. The coil component of claim 1, wherein a number of turns of the third coil portion is the same as a number of turns of the second coil portion.

16. The coil component of claim 3, wherein the cross-sectional area of the second core is the same as the cross-sectional area of the third core.

17. The coil component of claim 4, wherein the length of the entirety of the turn of the second coil portion is the same as the length of the entirety of the turn of the third coil portion.

18. A coil component, comprising:
a body having first and second surfaces opposing each other in a first direction;
at least three coil portions spaced apart from each other in the first direction in the body and having turns wound in the same direction with respect to a core, respectively; and
external electrodes disposed on the body and connected to both ends of the at least three coil portions, respectively,
wherein, among the at least three coil portions, the coil portion nearest to the first surface is defined as a first outermost coil portion, and the coil portion nearest to the second surface is defined as a second outermost coil portion, a number of turns of the first outermost coil portion in a region adjacent to the first surface is greater than a number of turns of the second outermost coil portion in a region adjacent to the second surface, and
wherein a distance between the first outermost coil portion and an adjacent coil portion is greater than a distance between other adjacent coil portions among the other coil portions.

19. The coil component of claim 18,
wherein the core includes a first core disposed in a winding center region of the first outermost coil portion, and
wherein a cross-sectional area of the first core is greater than a cross-sectional area of a core disposed in a winding center region of each of the other coil portions.

20. The coil component of claim 19, wherein the core disposed in a winding center region of each of the other coil portions has substantially the same cross-sectional area.

21. The coil component of claim 18, wherein a length of an entirety of the turn of the first outermost coil portion is longer than a length of an entirety of the turn of each of the other coil portions other than the first outermost coil portion.

22. The coil component of claim 21, wherein the entirety of the turn of each of the other coil portions other than the first outermost coil portion has substantially the same length.

23. The coil component of claim 18, wherein a distance between the first outermost coil portion and the first surface is substantially the same as the distance between the second outermost coil portion and the second surface.
